(19) United States
(12) Patent Application Publication
(10) Pub. No.: US 2006/0252327 A1
(43) Pub. Date: Nov. 9, 2006

(54) Scented product and method for manufacturing

(76) Inventors: David Raymond Uitenbroek, Sun Prairie Way, WI (US); Mark J. Weber, Stevens Point, WI (US); John E. Katchko, Rhinelander, WI (US); Michael W. Rekitzke, Green Bay, WI (US)

Correspondence Address: MERCHANT & GOULD PC, P.O. BOX 2903, MINNEAPOLIS, MN, 55402-0903, US

(21) Appl. No.: 11/118,086

(22) Filed: Apr. 28, 2005

(51) Int. Cl. B32B 5/02; B32B 27/04

(52) U.S. Cl. 442/149; 442/59

(57) ABSTRACT

The invention relates to a scented laminate product and a method for manufacturing a scented laminate product. In an embodiment, the invention includes a scented laminate having a first substrate; a second substrate; and a scented adhesive composition provided between the first substrate and the second substrate, the scented adhesive composition bonding the first substrate to the second substrate. In an embodiment, the invention includes a method of forming a scented laminate including the steps of applying a scented adhesive composition between a first substrate and a second substrate, thereby bonding the first substrate and the second substrate together to form a scented laminate. In an embodiment, the invention includes a scented paper product including a paper substrate; the paper substrate comprising a web of fibers and from about 0.1% wt. to about 25.0% wt. of a scented composition; the scented paper product configured to provide at least a one-month lasting scent.

### FIELD OF THE INVENTION

The invention relates to a scented product and a method for manufacturing a scented product.

### BACKGROUND OF THE INVENTION

Various types of products, including paper products, may be scented to increase consumer appeal. Scented products can be created by applying a scent emitting composition, such as a perfume or scented oil. However, the scent emitted by such products generally dissipates rapidly.

Effort has been directed at increasing the length of time scent is emitted from articles. See, for example, U.S. Pat. No. 5,607,754 (Giles et al.), U.S. Pat. No. 5,534,105 (Boyd), and U.S. Pat. No. 4,809,912 (Santini).

### BRIEF DESCRIPTION OF THE DRAWINGS

FIG. 1 is a schematic view of an exemplary process for manufacturing a substrate.

FIG. 2 is a schematic view of an exemplary process for creating a scented laminate from substrates according to the invention.

FIG. 3 is a schematic cross-sectional view of a scented laminate in accordance with an embodiment of the invention.

FIG. 4 is a schematic cross-sectional view of a scented laminate in accordance with another embodiment of the invention.

### SUMMARY OF THE INVENTION

A scented laminate is provided according to the invention. The scented laminate includes a first substrate, a second substrate, and a scented adhesive composition provided bonding the first substrate and the second substrate together.

A method of forming a scented laminate is provided according to the invention. The method includes steps of applying a scented adhesive composition between a first substrate and a second substrate, and bonding the first substrate and the second substrate together.

A scented paper product is provided according to the invention. The scented paper product includes a paper substrate comprising a web of fibers and about 0.1 wt. % to about 25 wt. % of a scented composition as measured on a dry weight basis, wherein the scented paper product is constructed to provide at least a one month lasting scent.

A method for forming a scented paper product is provided according to the invention. The method includes a step of applying a scented composition to a paper substrate to provide a scented paper product comprising about 0.1 wt. % to about 25 wt. % of the scented composition as measured on a dry basis, wherein in the scented paper product is constructed to provide at least a one month lasting scent.

### DETAILED DESCRIPTION

The invention relates to scented products. The invention can include scented laminate products. The term “laminate product” as used herein refers to a product that includes two or more layers of materials adhered together.

The term “scented composition” as used herein refers to a composition that emits a desired scent. The term “scented adhesive composition” as used herein refers to a composition that emits a desired scent and has adhesive properties.

The term “desired scent” as used herein shall refer to a fragrant or pleasing scent that has been intentionally provided in order to add commercial value to a product. Desired scents include those fragrances that can be obtained from “fragrance houses” that supply fragrances having desired scents. In general, one can purchase or formulate a fragrance to provide a desired scent. Paper products, polymers, or adhesives may have scents or odors due to the presence of solvents or other volatile components therein. In general, “desired scents” are generally not those scents or odors of a product that are present merely as a result of the components therein such as solvents or adhesives and that have not been intentionally provided for their olfactory properties.

Scented laminates and/or scented products described herein can emit a scent over an extended period of time. While not intending to be bound by theory, it is believed that providing a scent carrier in the scented composition or in the scented adhesive composition of the invention leads to increasing the length of time over which scent can be emitted.

In an embodiment, the invention includes a scented laminate having a first substrate; a second substrate; and a scented adhesive composition bonding the first substrate and the second substrate together. In an embodiment, the invention includes a method of forming a scented laminate including the steps of applying a scented adhesive composition between a first substrate and a second substrate, thereby bonding the first substrate and the second substrate together to form a scented laminate.

While not intending to be bound by theory, it is believed that laminating a scented adhesive composition between two substrates contributes to controlling the length of time over which scent is emitted. Further, some types of scent emitting compositions have waxy or oily tactile qualities. Therefore, providing the scented adhesive composition between two substrates, as in some embodiments of the invention, can render the product more desirable or easier to handle and use.

In an embodiment, the invention includes a scented paper product including a substrate; the substrate comprising a web of fibers and from about 0.1% wt. to about 25.0% wt. of a scented composition; the scented paper product configured to provide at least a one-month lasting scent. In an embodiment, the invention includes a method of forming a scented paper product comprising the steps of applying a scented composition to a paper substrate in an amount equal to about 0.1% wt. to about 25.0% wt. of the paper substrate as measured on a dry weight basis; the scented paper product configured to provide at least a one month lasting scent.

While not intending to be bound by theory, it is believed that the scented composition can at least partially penetrates into the web of fibers and this can contribute to controlling the length of time over which scent is emitted.

One of skill in the art will appreciate that the invention has many applications. For example, scented products or laminates of the invention can be used as a drawer liner, a shelf liner, as wallpaper, as an air freshening strip, as a sign or banner, and the like. Air freshening strips can include those that adhere to a surface, such as a locker or a closet wall, as well as those that are merely placed in a desired location such as under a car seat. Signs or banners made with the scented products of the invention have many applications, such as in retail environments. Scented products or laminates of the invention can have adhesive backings, allowing them to stick to other things either temporarily or permanently.

Scented products can be created in accordance with the invention having any of a wide variety of scents. Exemplary scents include crisp cotton, cedar, lavender, pine, floral, rose, apple, cherry, and the like.

Scented Paper Product

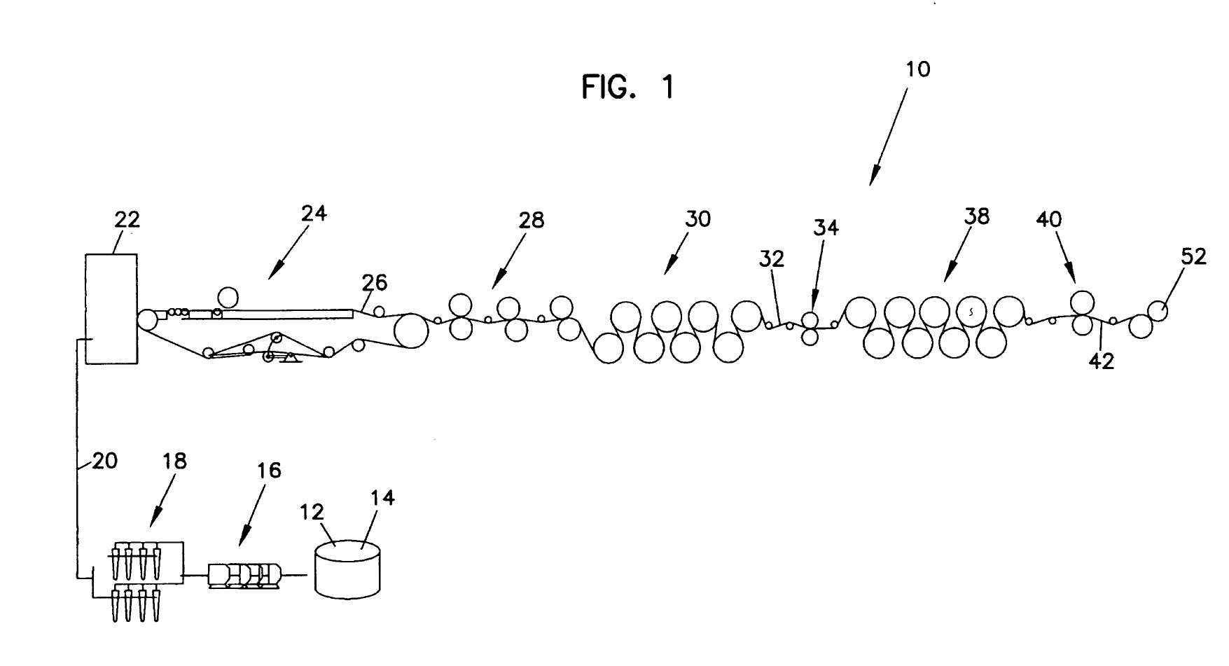

In an embodiment, the invention includes a scented paper product having a paper substrate. Referring to FIG. 1, a schematic view of an exemplary process 10 for manufacturing a scented paper product is shown. It should be understood that FIG. 1 is an exemplary schematic view and includes many of the operations carried out in commercial paper making facilities. While the equipment used in a particular operation may vary from facility to facility, it is expected that the same general operations will be present.

The starting material 12 generally includes wood pulp 14. The wood pulp can include a blend of hard wood and soft wood fibers. The wood pulp can be provided as cellulose fiber from chemical pulped wood, and can include a blend from coniferous and deciduous trees. The fibers can also be bleached or unbleached. The wood pulp 14 can be processed through a refining operation 16 and through a cleaning operation 18. The cleansed pulp 20 is then applied through a head box 22 onto a fourdrinier machine 24 to provide a paper base sheet 26. Certain additives can be added at or prior to the head box 22 to provide various qualities and this is referred to as “wet end chemistry.” These additives are described more fully below.

The paper base sheet 26 can be characterized as continuous in the machine direction. The paper base sheet 26 can be processed through a wet press section 28 to remove water, and then through a drier section 30 to further reduce the water content and provide a web of fibers 32.

The web of fibers 32 can be processed through a size press 34 for the application of a surface treatment. Certain additives can be added to the size press solution and this can be referred to as size press chemistry. A scented composition can be added to the web of fibers at the size press in order to produce a scented paper product. The scented composition applied at the size press can be an emulsion. The scented composition used with the scented paper product of the invention can include various components.

The scented composition can include a component that can serve as a scent carrier. By way of example, suitable scent carriers include waxes. Suitable waxes can include microcrystalline waxes, paraffin waxes, and synthetic waxes (such as various types of copolymers and homopolymers). In an embodiment, the scented composition comprises a microcrystalline wax. Exemplary microcrystalline waxes can include those having a molecular weight from about 400 to about 900. Suitable microcrystalline waxes can have a melting point from about 140 to about 350 degrees Fahrenheit. Exemplary microcrystalline waxes include WAXREX® available from ExxonMobil Oil Corporation, Irving, Tex., and BLEND-KOTE™ available from CITGO Petroleum Corporation, Houston, Tex. Paraffin waxes can have a molecular weight of about 300 to about 600. Exemplary paraffin waxes can have a melting point of about 120 to about 160 degrees Fahrenheit. Synthetic waxes used herein can have a molecular weight of about 200 to about 4000. Exemplary synthetic waxes can have a melting point of about 120 to about 400 degrees Fahrenheit. The scented composition can also include combinations of different waxes.

The scent carrier can be provided in an amount sufficient to contain or carry a desired amount of a fragrant component. By way of example, the scent carrier can be greater than or equal to about 10.0 wt. % (solids) in the scented composition. The scent carrier can be less than or equal to about 98.0 wt. % (solids) in the scented composition. As an exemplary range, the scent carrier can be from about 10.0 wt. % to about 98.0 wt. % (solids) in the scented composition. The scent carrier can be from about 80.0 wt. % to about 98.0 wt. % (solids) of the scented composition. In a particular embodiment, the scent carrier is about 89.5 wt. % (solids) of the scented composition.

The scented composition can include a fragrant component, such as a fragrance. The fragrant component can be any component that can be used in the scented composition to emit a desired scent when applied to a paper substrate to form a scented laminate and/or a scented product. The selection of the fragrant component can vary widely and can be subject to personal preferences. That is, certain people may prefer certain fragrances over other fragrances. Nevertheless, various fragrances are available from “fragrance houses” that commercially supply fragrances for various applications. One can select a fragrance that would be desired for a particular laminate or scented product application. The fragrant component can be selected so that it is compatible with the other components of the scented composition. By compatible, it is meant that the fragrant component does not adversely react or interact with other components in the composition to create an unpleasing scent or destroy the fragrance. In addition, the fragrant component can be selected so that it remains a part of the scented composition and releases scent over a desired length of time. An example of a fragrant component that can be used includes one having a specific gravity of about 0.9 to about 1.1. In addition, the fragrant component can have a refractive index of about 1.45 to about 1.5, and the fragrant component can have a viscosity of about 5 cps to about 15 cps (RT).

The scented composition should have a sufficient amount of the fragrant component to have desired scent qualities. As an example, the scented composition includes at least about 0.5 wt. % (solids) of the fragrant component. Using too much of the fragrant component may not be economically efficient. As an example, the scented composition can include about 25.0 wt. % (solids) or less of the fragrant component. As a further example, the scented composition includes from about 0.5 wt. % to about 25.0 wt. % (solids) of the fragrant component. The scented composition can include from about 5.0 wt. % to about 10.0 wt. % (solids) of the fragrant component. In an embodiment, the scented composition includes about 5.0 wt. % (solids) of the fragrant component.

The scented composition can include a stabilizing component. The stabilizing component helps to solidify the scented composition. It is believed that the stabilizing component interacts with oils that may be present in the scented composition. Stabilizing components can include polymerized alpha olefin stabilizers. Exemplary stabilizing components can have a molecular weight of about 2000 to about 5000. Exemplary stabilizing components can have a melting point of about 120 to about 300 degrees Fahrenheit. An exemplary stabilizing component is VYBAR® available from Baker Petrolite, Sugar Land, Tex.

The scented component should contain enough of a stabilizing component to allow the scented composition to solidify. The scented composition can contain at least about 0.1 wt. % (solids) of a stabilizing component. Using too much of a stabilizing component may not be economically efficient. The scented composition can contain less than about 25.0 wt. % (solids) of the stabilizing component. As an example, the scented composition contains from about 0.1 wt. % to about 25.0 wt. % (solids) of the stabilizing component. As another example, the scented composition can contain from about 0.1 wt. % to about 3.0 wt. % (solids) of the stabilizing component. In a particular embodiment, the scented composition contains about 0.5 wt. % (solids) of the stabilizing component.

Applying the scented composition in amounts greater than necessary can lead to difficulties with the product. The scented composition can be applied in an amount less than or equal to 25.0 wt. % of the paper substrate. As an example, the scented composition is applied in an amount of less than or equal to 50 pounds per 3000 ft² of scented product. The scented composition should be applied in amounts large enough so that the scented product has the desired scented properties. The scented composition can be applied in an amount greater than or equal to 0.1 wt. % of the paper substrate. As an example, the scented composition is applied in an amount of greater than or equal to 1 pound per 3000 ft² of scented product. As a further example, the scented composition can be applied as a coat of about 1 pound per 3000 ft² to about 50 pounds per 3000 ft² of scented product. The scented composition can be applied in an amount of about 10 to about 15 pounds per 3000 ft² of scented product.

As discussed above, the scented composition can be applied to the paper substrate at the size press. However, one of skill in the art will appreciate that it is possible to apply the scented composition at other points in the paper making process or off-line.

After passing through the size press, the web of fibers is then dried in a second drier section 38 and calendered in a machine calender 40 to provide a scented paper product 42. The scented paper product 42 can then be sent to a winder and put on a roll 52. The scented paper product 42 can also be processed further. By way of example, the scented paper product 42 can be cut to a smaller size for end use. As a further example, the scented paper product 42 can be printed on for aesthetic purposes.

Scented Laminate

In some embodiments, the invention is a laminate including a first substrate, a second substrate, and a scented adhesive composition provided between the first substrate and the second substrate. The substrates of the laminate can include a variety of materials including a web of fibers, films, foils, or the like. Films can include polymeric films such as polyester, polypropylene, polyethylene, cellophane, nylon, and the like. The first substrate and the second substrate may be the same material or different materials. In addition, it should be understood that a web of fibers can include a single ply or multiple plys.

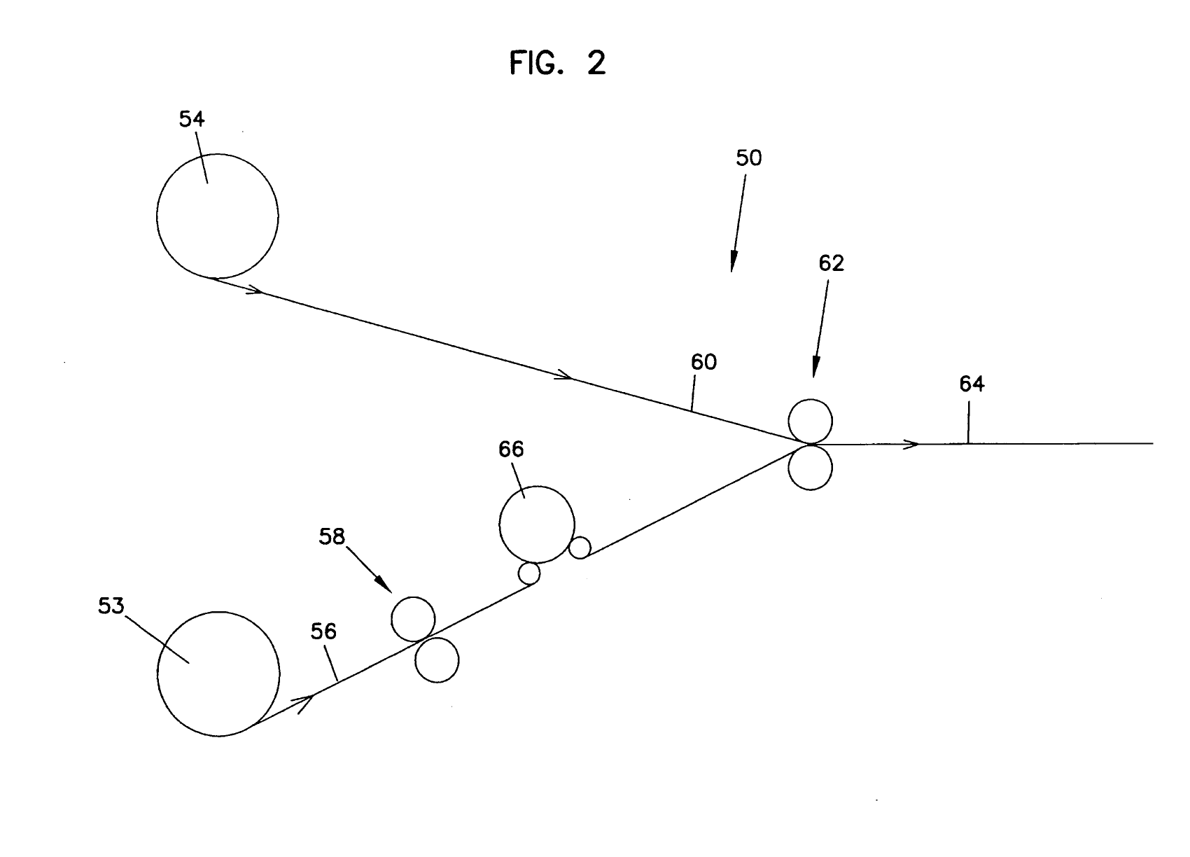

Substrates can be made into a scented laminate in accordance with methods of the invention. Referring to FIG. 2, a diagrammatic view is shown of an exemplary process 50 for creating a laminate from individual substrates according to the invention. In FIG. 2, the first substrate 56 is unwound from a roll 53 before receiving an amount of scented adhesive composition from an applicator 58. The applicator could be a rod coater, three roll coater, hot melt coater, knife coater, or the like. The first substrate 56 then passes over a heated dryer can 66 that keeps the scented adhesive composition molten and promotes some amount of penetration before the first substrate 56 is fed into a nip roller 62.

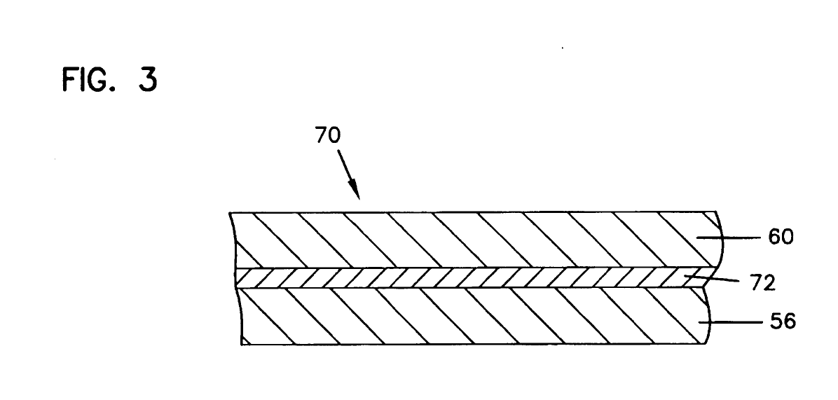

Simultaneously, the second substrate 60 is unwound from a roll 54 and then fed into the nip roller 62. The nip roller 62 forms a scented laminate 64 by forcing together the first substrate 56, the scented adhesive composition layer 72 (shown in FIG. 3), and the second substrate 60. The scented laminate 64 is then wound onto a roll or subjected to further processing such as cutting, packaging, or the like.

FIG. 3 shows a schematic cross-sectional view of a scented laminate 70 in accordance with one embodiment of the invention. A first substrate 56 is adhered to a scented adhesive composition layer 72 that is, in turn, adhered to a second substrate 60.

The scented laminate includes a scented adhesive composition provided between the first substrate and the second substrate to bond the substrates together. The scented adhesive composition of the invention may have various qualities. For example, the scented adhesive composition can have properties including tackiness, elasticity, and the ability to hold a fragrant component. The scented adhesive composition of the invention should have a tackiness sufficient to adhere the first substrate to the second substrate. The scented adhesive composition should also have an elasticity sufficient to stay pliable and/or flexible after being formed into a scented laminate. The scented adhesive composition can be 100% solids. However, it will be appreciated that solvents could be added if desired.

Different components may be used to provide the scented adhesive composition with the desired qualities. By way of example, tackiness may be provided by the inclusion of a tacky component into the scented adhesive composition. Suitable tackifiers include aliphatic hydrocarbon resins. Suitable tackifiers can include piperylene/butene/pentene terpolymers. Suitable tackifiers can include those having a molecular weight from about 700 to about 4000. An exemplary tacky component is PICCOTAC® available from Eastman Chemical, Kingsport, Tenn.

An amount of a tacky component (tackifier) should be used in the scented adhesive composition that is sufficient to adhere the substrates of the laminate together. As an example, the scented adhesive composition includes at least about 1.0 wt. % (solids) of the tacky component. Using too much of the tacky component may result in a scented adhesive composition that is difficult to work with. By way of example, the scented adhesive composition can include less than about 50.0 wt. % (solids) of the tacky component. The scented adhesive composition can include from about 1.0 wt. % (solids) of the tacky component to about 50.0 wt. % (solids) of the tacky component. As a further example, the scented adhesive composition can include from about 1.0 wt. % (solids) to about 10.0 wt. % (solids) of the tacky component. In a particular embodiment, the scented adhesive composition contains about 3.0 wt. % (solids) of the tacky component.

The type and amount of the tackifier used in the scented adhesive composition can vary depending on the strength of the bond desired between the first substrate and the second substrate. The laminated structure bond strength can be measured in accordance with TAPPI test method T540. The laminate should have a strong enough bond between the first substrate and the second substrate such that the laminate does not separate in the course of end use of the scented laminate. By way of example, the bond strength can be at least about 1 g/in. The bond strength can be at least about 10 g/in., and can be at least about 20 g/in. The bond strength can be sufficient so that delamination occurs as a result of fiber-tear within a paper substrate. Such a bond strength can be referred to as a fiber-tear bond. By way of example, the bond strength can be sufficient to provide a fiber-tear bond, and can be provided at less than about 260 g/in., which can be less than the fiber-tear bond strength.

Elasticity of the scented adhesive composition can be provided by the inclusion of elastic components into the scented adhesive composition. By way of example, elastic components can include polymers such as ethylene vinyl acetate copolymers and terpolymers. Suitable elastic components can include those having a density from about 0.90 to about 0.99 (g/cm³). Suitable elastic components include those having a melting point from about 130 to about 250 degrees Fahrenheit. An exemplary elastic component is sold as ELVAX®, available from DuPont, Wilmington, Del. Enough of the elastic component should be used so that scented adhesive composition has desired levels of flexibility. As an example, the scented adhesive composition can include at least about 0.1 wt. % (solids) of the elastic component. Using too much of the elastic component may not be economically efficient. By way of example, the scented adhesive composition can include less than about 50.0 wt. % (solids) of the elastic component. The scented adhesive composition can include from about 0.1 wt. % (solids) to about 50.0 wt. % (solids) of the elastic component. As a further example, the scented adhesive composition can include from about 0.1 wt. % (solids) to about 10.0 wt. % (solids) of the elastic component. In a particular embodiment, the scented adhesive composition can include about 2.0 wt. % (solids) of the elastic component.

The scented adhesive composition includes a component that can serve as a scent carrier. By way of example, suitable scent carriers include waxes. Suitable waxes can include microcrystalline waxes, paraffin waxes, and synthetic waxes (such as various types of copolymers and homopolymers). Suitable scent carriers can be as described above.

The scent carrier should be present in an amount sufficient to carry a desired amount of scent. By way of example, the scent carrier can be greater than or equal to about 10.0 wt. % (solids) of the scented adhesive composition. If too much of the scented adhesive composition is composed of the scent carrier, the scented adhesive composition may not have desired levels of adhesiveness. The scent carrier can be less than or equal to about 98.0 wt. % (solids) of the scented adhesive composition. The scent carrier can be from about 10.0 wt. % (solids) to about 98.0 wt. % (solids) of the scented adhesive composition. By way of example, the scent carrier can be about 80.0 wt. % (solids) to about 98.0 wt. % (solids) of the scented adhesive composition. In a particular embodiment, the scent carrier can be about 89.5 wt. % (solids) of the scented adhesive composition.

The scented adhesive composition includes a fragrant component, such as a fragrance. The fragrant component can be as described above. If the scented adhesive composition does not have a sufficient amount of the fragrant component, the scented adhesive composition may not have desired scent qualities. The scented adhesive composition can include at least about 0.5 wt. % (solids) of the fragrant component. Using too much of the fragrant component may not be economically efficient. The scented adhesive composition can include about 25.0 wt. % (solids) or less of the fragrant component. As an example, the scented adhesive composition can include about 0.5 wt. % (solids) to about 25.0 wt. % (solids) of the fragrant component. As a further example, the scented adhesive composition can include about 5.0 wt. % (solids) to about 10.0 wt. % (solids) of the fragrant component. In an embodiment, the scented adhesive composition can include about 5.0 wt. % (solids) of the fragrant component.

The scented adhesive composition can include a stabilizing component. The stabilizing component can help to solidify the scented adhesive composition. Stabilizing components can be as described above.

An amount of a stabilizing component can be used sufficient to solidify the scented adhesive composition. As an example, the scented adhesive composition can contain at least about 0.1 wt. % (solids) of a stabilizing component. Using too much of a stabilizing component may not be economically efficient. As an example, the scented adhesive composition can contain less than about 25.0 wt. % (solids) of the stabilizing component. The scented adhesive composition can contain about 0.1 wt. % (solids) to about 25.0 wt. % (solids) of the stabilizing component. As another example, the scented adhesive composition can contain about 0.1 wt. % (solids) to about 3.0 wt. % (solids) of the stabilizing component. In a particular embodiment, the scented adhesive composition can contain about 0.5 wt. % (solids) of the stabilizing component.

Applying the scented adhesive composition in amounts greater than necessary can be messy and lead to difficulties handling the laminate product. As an example, the scented adhesive composition is applied in a coat of less than or equal to 35 pounds per 3000 ft² of scented laminate. The scented adhesive composition should be applied in an amount sufficient to adhere the two substrates together. As an example, the scented adhesive composition can be applied in a coat of greater than or equal to about 2 pounds per 3000 ft² of scented laminate. The scented adhesive composition can be applied as a coat of about 2 pounds per 3000 ft² of scented laminate to about 35 pounds per 3000 ft² of scented laminate. In a particular embodiment, the scented adhesive composition can be applied as a coat of about 15 pounds per 3000 ft² of scented laminate.

The scented adhesive composition can be applied with many devices including a rod coater, a three roll coater, a hot melt coater, knife coater, and a slot die coater. The scented adhesive composition may be applied either on-machine or off-machine.

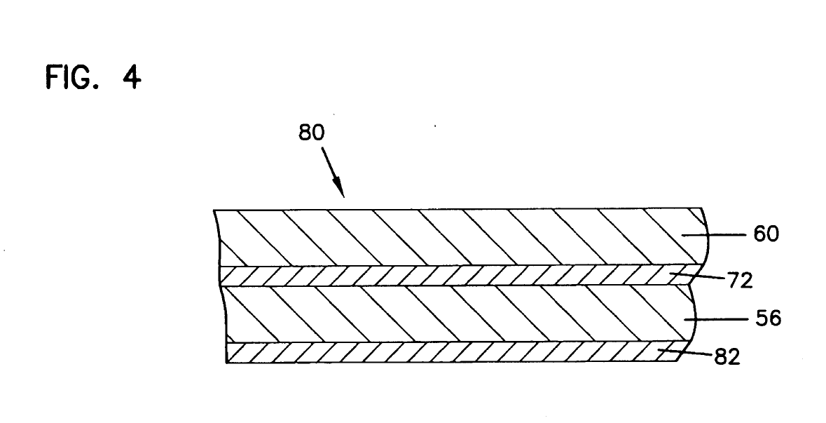

Other components may be included with the laminate of the invention. For some types of products, such as a shelf liner, it may be desirable if the scented laminate can adhere to a surface. Therefore, by way of example, a layer of an adhesive can be applied to the laminate of the invention. FIG. 4 shows a schematic cross-sectional view of a laminate 80 in accordance with another embodiment of the invention. A first substrate 56 is adhered to a scented adhesive composition layer 72 that is in-turn adhered to a second substrate 60. An adhesive layer 82 is provided on the first substrate 56. While shown on the first substrate 56, the adhesive layer could be provided on either or both of the first substrate 56 and the second substrate 60. Many different types of adhesives are known in the art and can be used to form the adhesive layer 82.

Webs of Fibers

The paper substrate of the scented paper product of the invention can include a web of fibers. Additionally, the substrates of the scented laminate of the invention can include webs of fibers. Webs of fibers are generally made with fibers from wood pulp. The wood pulp can be provided as cellulose fiber from chemical pulped wood, and can include a blend from coniferous and deciduous trees. By way of example, the fibers can be from Northern hardwood, Northern softwood, Southern hardwood, or Southern softwood. Blends of hardwood and softwood fibers are frequently used. The fibers can also be bleached or unbleached. The fibers may also include synthetic fibers.

Enough of a total fiber weight should be used so that substrates are strong enough to be processed by paper making equipment. As an example, the webs of fibers can be greater than about 15 pounds per 3000 ft² of paper. The webs of fibers can be less than about 200 pounds per 3000 ft² of paper. As an example, the web of fibers of the substrates can be in the range of about 15 to about 200 pounds per 3000 ft² of paper. As a further example, the web of fibers of the substrates may be in the range of 20 to 40 pounds per 3000 ft² of paper. In a specific embodiment, the web of fibers of the substrates may be about 27 pounds per 3000 ft² of paper.

The permeability of the webs of fibers may be measured in accordance with TAPPI test T494 with a Gurley densitometer. In an embodiment, the permeability of the webs of fibers can be about 1 to about 1,000,000 sec/100 cc.

Cobb testing measures the water absorption rate of a paper sample and is expressed as the amount of water pick-up per unit surface area of paper over a defined length of time. Cobb testing can be performed in accordance with TAPPI method T441. The webs of fibers of the invention have a water Cobb of at least about 10 g/m² (1 min.). The webs of fibers can have a water Cobb of no greater than 100 g/m² (1 min.). As an example, the webs of fibers can have a water Cobb of about 10 g/m² (1 min.) to about 100 g/m² (1 min.).

Oil and grease resistance properties of a paper sample can be measured using the kit test and is expressed as the amount of oil or grease pick-up per unit surface area of paper over a defined length of time. The kit test can be performed in accordance with TAPPI test method T559. As an example, the webs of fibers can have a grease resistance measurement of about 0.0 g/m² (1 min.) or more. The webs of fibers can have a grease resistance measurement of about 14.0 g/m² (1 min.) or less. As an exemplary range, the webs of fibers have a grease resistance measurement of between about 0.0 g/m² (1 min.) and about 14.0 g/m² (1 min.).

Tensile strength of a substrate can be measured in accordance with TAPPI test method T494. The substrates used in the laminate of the invention should have sufficient tensile so that the finished laminate product can perform as desired without tearing apart. As an example, the substrates have a tensile strength of at least about 5 lbs/in as measured in the cross-direction. The substrates can have a tensile strength of at least about 5 lbs/in as measured in the machine-direction. It may be economically inefficient to use substrates having a tensile strength that is greater than necessary to produce a sufficiently strong laminate product. As an example, the substrates can have a tensile strength of about 120 lbs/in or less in the cross-direction. The substrates can have a tensile strength of about 200 lbs/in or less in the machine-direction. As an exemplary range, the substrates have a tensile strength of between about 5 lbs/in and 120 lbs/in in the cross-direction. As an exemplary range, the substrates have a tensile strength of about 5 lbs/in to 200 lbs/in in the machine-direction.

Where the invention is a scented laminate, including a first substrate and a second substrate, the second substrate may be made with paper that is the same as the first substrate in terms of weight, permeability, etc. It is believed that this can provide an advantage in terms of handling and inventory management. However, the second substrate can also be different than the first substrate in terms of weight, permeability, etc.

Lasting Scent

Scented paper products and scented laminates of the invention can emit a desired scent that can still be detected by a consumer after a period of time in the environment of end use. The scented products and laminates of the invention can have a lasting scent. The term “lasting scent” as used herein refers to a desired scent that is detectable by at least half the members of a panel of four testers having an average sense of smell after a given period of time. By way of example, a product with a one-month lasting scent would have a desired scent after at least one month under the normal conditions of end use that is detectable by at least half of the members of a panel of four testers. Therefore, a shelf-liner with a one-month lasting scent would still have a detectable desired scent to at least half of a panel of testers after one month. The scented paper products or scented laminates of the invention can also have a two-month lasting scent. The scented paper products or scented laminates of the invention can also have a three-month lasting scent.

The scented paper product or scented laminate can be packaged in order to preserve scented qualities before being opened for end use. For example, the scented paper product or scented laminate can be put in a package that prevents the scent from migrating out of the product. Exemplary packages include polymeric packages, such as a polyethylene bag. Many different packaging configurations could be used. For example, a polyethylene bag could be put into a cardboard box. The cardboard box itself could also be provided with a scent sufficient to be detectable by a consumer when the product is on the shelf in a store.

Even in appropriate packages, the scented qualities of scented products and scented laminates can gradually dissipate. The term “shelf life” as used herein refers to the length of time in which a product or laminate of the invention can be sealed in packaging before being opened and used providing a desired scent that is detectable by at least half the members of a panel of four testers. It is desirable for the product or laminate to have a shelf-life sufficient to provide commercial value. As an example, the product or laminate of the invention can have a shelf-life of at least about six months. As a further example, the product or laminate of the invention can have a shelf-life of at least about seven months. The product of the invention could also have shelf-life of at least about eight months.

The invention has been described with reference to various specific and preferred embodiments and techniques. However, it should be understood that many variations and modifications may be made while remaining within the spirit and scope of the invention.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A scented laminate comprising:
a first substrate;
a second substrate; and
a scented adhesive composition provided bonding the first substrate and the second substrate together.

2. The scented laminate of claim 1, wherein the laminate exhibits a bond strength of at least about 1 g/in. as measured according to TAPPI test method T540.

3. The scented laminate of claim 1, wherein the laminate exhibits a bond strength of at least about 10 g/in. as measured according to TAPPI test method T540.

4. The scented laminate of claim 1, the scented adhesive composition comprising about 1.0 wt. % to about 50.0 wt. % of a tacky component.

5. The scented laminate of claim 4, the tacky component comprising an aliphatic hydrocarbon resin.

6. The scented laminate of claim 1, the scented adhesive composition comprising about 0.1% to about 50.0 wt. % of an elastic component.

7. The scented laminate of claim 6, wherein the elastic component comprises ethylene-vinyl acetate.

8. The scented laminate of claim 1, the scented adhesive composition comprising about 10.0 wt. % to about 98.0 wt. % of a scent carrier.

9. The scented laminate of claim 8, the scent carrier comprising one or more of microcrystalline waxes, paraffin waxes, and synthetic waxes.

10. The scented laminate of claim 1, the scented adhesive composition comprising from about 0.1 wt. % to about 25.0 wt. % of a stabilizer.

11. The scented laminate of claim 10, the stabilizer comprising a polymerized alpha olefin.

12. The scented laminate of claim 1, the scented adhesive composition comprising about 0.5 wt. % to about 25.0 wt. % of a fragrant component.

13. The scented laminate of claim 1, the first substrate comprising a web of fibers having a weight from about 15 to about 200 pounds per 3000 ft².

14. The scented laminate of claim 1, the second substrate comprising a web of fibers having a weight from about 15 to about 200 pounds per 3000 ft².

15. The scented laminate of claim 1, the first substrate comprising a web of fibers having a water Cobb of about 10 to about 100 g/m² (1 min.) as measured according to TAPPI test method T441.

16. The scented laminate of claim 1, the second substrate comprising a web of fibers having a water Cobb of about 10 to about 100 g/m² (1 min.) as measured according to TAPPI test method T441.

17. The scented laminate of claim 1, the first substrate comprising a web of fibers having a grease resistance of about 0 to about 14 g/m² (1 min.) as measured according to TAPPI test method T559.

18. The scented laminate of claim 1, the second substrate comprising a web of fibers having a grease resistance of 0 to about 14 g/m² (1 min.) as measured according to TAPPI test method T559.

19. The scented laminate of claim 1, the first substrate comprising a web of fibers having a tensile strength of about 5 to about 120 g/m² (1 min.) as measured in the cross-direction according to TAPPI test method T494.

20. The scented laminate of claim 1, the second substrate comprising a web of fibers having a tensile strength of about 5 to about 120 g/m² (1 min.) as measured in the cross-direction according to TAPPI test method T494.

21. The scented laminate of claim 1, the first substrate comprising a web of fibers having a tensile strength of about 5 to about 200 g/m² (1 min.) as measured in the machine-direction according to TAPPI test method T494.

22. The scented laminate of claim 1, the second substrate comprising a web of fibers having a tensile strength from about 5 to about 200 g/m² (1 min.) as measured in the machine-direction according to TAPPI test method T494.

23. The scented laminate of claim 1, wherein one of the first or second substrates comprises a film or a foil.

24. The scented laminate of claim 1, having at least a one month lasting scent.

25. A method of forming a scented laminate comprising the steps of:
applying a scented adhesive composition between a first substrate and a second substrate; and
bonding the first substrate and the second substrate together to form the scented laminate.

26. The method of claim 25, the laminate exhibiting a bond strength of at least about 1 g/in as measured according to TAPPI test method T540.

27. The method of claim 25, the laminate exhibiting a bond strength of at least about 10 g/in as measured according to TAPPI test method T540.

28. The method of claim 25, the scented adhesive composition comprising about 1.0 wt. % to about 50.0 wt. % of a tacky component.

29. The method of claim 28, the tacky component comprising an aliphatic hydrocarbon resin.

30. The method of claim 25, the scented adhesive composition comprising about 0.1 wt. % to about 50.0 wt. % of an elastic component.

31. The method of claim 25, the scented adhesive composition comprising about 10.0 wt. % to about 98.0 wt. % of a scent carrier.

32. The method of claim 31, the scent carrier comprising one or more of microcrystalline waxes, paraffin waxes, and synthetic waxes.

33. The method of claim 25, the scented adhesive composition comprising from about 0.1 wt. % to about 25.0 wt. % of a stabilizer.

34. The method of claim 33, the stabilizer comprising a polymerized alpha olefin.

35. The method of claim 25, the scented adhesive composition comprising about 0.5 wt. % to about 25.0 wt. % of a fragrant component.

36. The method of claim 25, wherein the scented adhesive composition is applied as a coat of about 2 to about 35 pounds of the scented adhesive composition per 3000 ft².

37. The method of claim 25, the laminate having at least a one month lasting scent.

38. A scented paper product comprising:
a paper substrate comprising a web of fibers and about 0.1% wt. to about 25.0% wt. of a scented composition as measured on a dry weight basis; wherein the scented paper product is constructed to provide at least a one month lasting scent.

39. The scented paper product of claim 38, the scented composition comprising about 10.0 wt. % to about 98.0 wt. % of a scent carrier.

40. The scented paper product of claim 39, the scent carrier comprising one or more of microcrystalline waxes, paraffin waxes, and synthetic waxes.

41. The scented paper product of claim 38, the scented composition comprising about 0.1 wt. % to about 25.0 wt. % of a stabilizer.

42. The scented paper product of claim 38, the stabilizer comprising a polymerized alpha olefin.

43. The scented paper product of claim 38, the scented composition comprising about 0.5 wt. % to about 25.0 wt. % of a fragrant component.

44. A method of forming a scented paper product comprising:
applying a scented composition to a paper substrate to provide a scented paper product comprising about 0.1% wt. to about 25.0% wt. of the scented composition as measured on a dry weight basis; the scented paper product is constructed to provide a one month lasting scent.
